(19) United States
(12) Patent Application Publication
(10) Pub. No.: US 2023/0165219 A1
(43) Pub. Date: Jun. 1, 2023

(54) PET CHEWING TOY AND TREAT HOLDER

(71) Applicants: Mike Q. Zheng, Clarksburg, MD (US); Kevin Y. Liu, Vienna, VA (US)

(72) Inventors: Mike Q. Zheng, Clarksburg, MD (US); Kevin Y. Liu, Vienna, VA (US)

(21) Appl. No.: 17/535,866

(22) Filed: Nov. 26, 2021

(51) Int. Cl. A01K 15/02

(52) U.S. Cl. CPC A01K 15/026

(57) ABSTRACT

An apparatus for a chewable treat holder and pet toy may be shown and described. An exemplary embodiment may include two clamping blocks which are clamped together via top and bottom knobs. Each top knob is connected to a threaded rod which is screwed into a nut embedded in a bottom knob. A pet treat may be clamped between the two clamping blocks, which can be clamped by tightening the knobs on the top and bottom of the blocks. The clamping blocks and tightening knobs may be composed of a pet-friendly material and may be able to withstand stress from chewing. The knobs may fully contain the threaded rods and the nuts such that no part of the threaded rods or nuts is exposed to animals.

### FIELD

An exemplary embodiment relates to chewable pet toys.

### BACKGROUND

Pet treats come in a variety of shapes and forms, such as sheets, bars, sticks, chips, and strips, etc. When consumed in appropriate manner and pace, treats can provide many benefits to the pets. However, many pets, such as dogs or cats, tend to eat treats quickly or swallow them without fully chewing, which not only significantly reduces the treat consumption time, but also imposes a choking risk to the pets. A pet treat holding device can securely hold the treats and therefore prevent pets from swallowing big chunk of treats and force the pets to spend more time to consume the treats. The treat holder itself can also serve as a chew toy and it may be made of a suitable nontoxic material that can withstand stress as well as not become a choking hazard.

### SUMMARY

According to at least one exemplary embodiment, a method, system and apparatus for a chewable treat holder and pet toy may be shown and described. An exemplary embodiment may include two clamping blocks which are clamped together via top and bottom tightening knobs. Each top tightening knob may be connected to a threaded rod which can be screwed into a nut embedded in the bottom tightening knob. A pet treat may be clamped between the two clamping blocks, which can be clamped by tightening the knobs on the top and bottom of the blocks. The clamping blocks and tightening knobs may be composed of a pet-friendly material and may be able to withstand stress from chewing. The knobs may fully contain the threaded rod such that no part of the threaded rod is exposed to the animal.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary embodiment of a pet chewing device with a treat.

FIG. 2 is an exemplary embodiment of an exploded view of a pet chewing device.

FIG. 3 is an exemplary embodiment of a fully closed pet chewing device.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

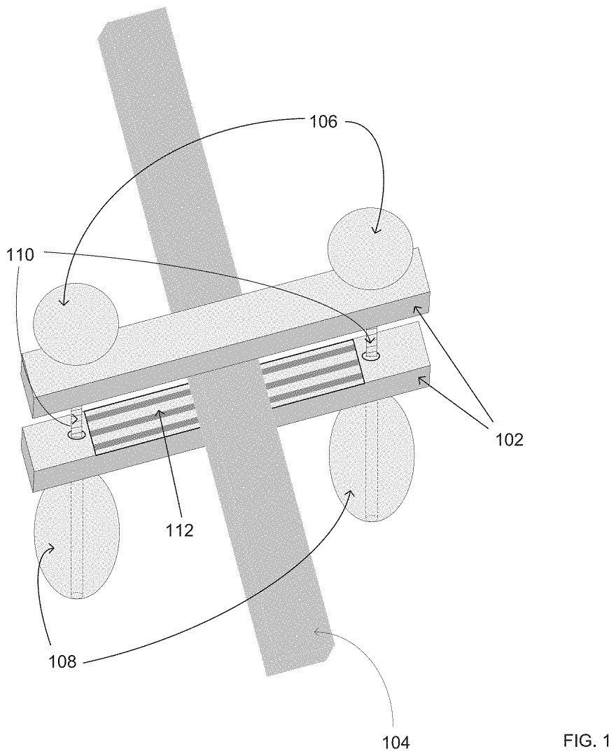

An exemplary embodiment may provide a chew device for pets. An embodiment may securely hold a treat within the chew toy. For example, FIG. 1 may illustrate an exemplary treat holder chewing device. The device may include parallel blocks 102. A treat 104 may be clamped in between the blocks 102. Each of the tightening knobs 106 (top knob) may be connected to a threaded rod 110 which passes through the holes on the two blocks 102 and may be screwed into a nut 114 embedded in a tightening knob 108 (bottom knob). The bottom knob 108 may contain a through-hole 116 beyond the embedded nut to accommodate the extra length of the threaded rod when it is tightened.

The bottom knob 108 may be sized such that no part of the rod 110 can extend beyond the bottom knob 108. The tightening knobs 106 and 108 and the blocks 102 may be formed from any contemplated material suitable for chewing by animals, such as rawhide, bone-like material, rubber, or nylon.

The rods 110 and the internal nuts of the bottom knobs 108 may be metal, plastic, or other strong materials. The entirety of the rods 110 and nuts may be contained within the knobs 106/108 and blocks 102.

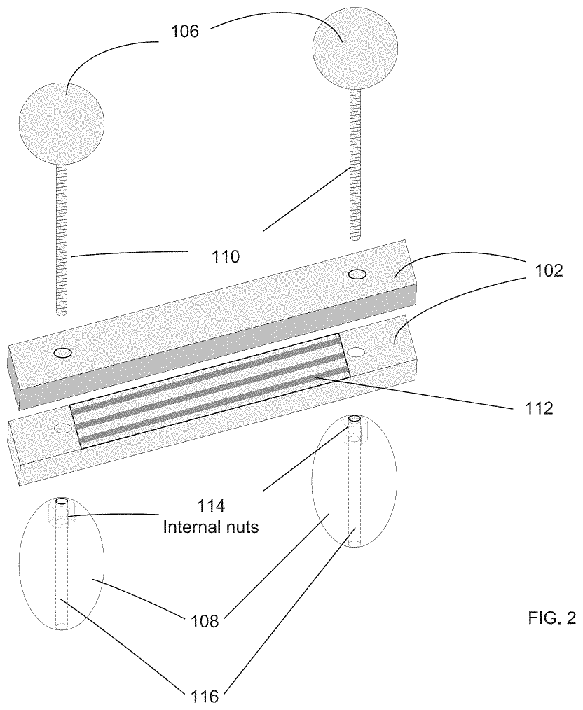

Referring now to FIG. 2, FIG. 2 may illustrate an exploded view of an exemplary device. The blocks 102 may include holes through which the rods 110 of the knob 106 pass through. Further, the blocks 102 may include rugged surface such as grooves or a tongue and groove pattern 112 in order to further secure the treat clamped in between.

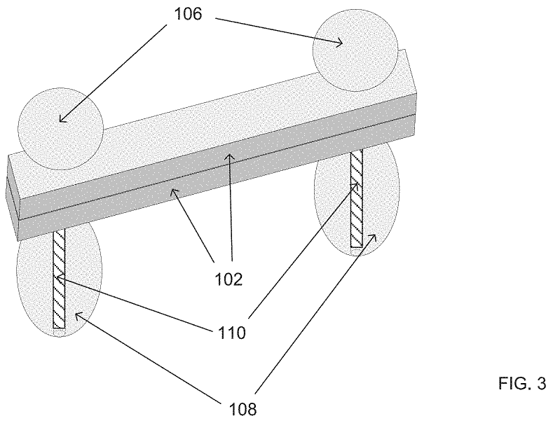

FIG. 3 may illustrate an exemplary embodiment without a treat. In an exemplary embodiment, the blocks 102 may be fully closed to form a chew toy. The rods 110 and knobs 108 may be sized such that the rods 110 are fully contained within the knobs, even when no treat is between the fully closed blocks 102. By ensuring that the rods 110 are fully contained within the bottom knobs 108, the device may be made safer.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A pet treat holder and chewing device comprising:
two clamping blocks, each block comprising two through-holes;
two top tightening knobs, each top tightening knob connected to a threaded rod which is placed through the through-holes of the clamping blocks, such that the tightening knobs are on a top side of the clamping blocks and the threaded rod extends from the top side to a bottom side of the clamping blocks; and
two bottom tightening knobs, each bottom tightening knob comprising an embedded nut, wherein the bottom knobs receive the threaded rods from the bottom side of the clamping blocks;
wherein the top tightening knobs, bottom tightening knobs, and clamping blocks are formed from a chewable material comprising one or more of nylon, rubber, rawhide, or bone-like materials.

2. The pet chewing device of claim 1, further comprising a treat, wherein the treat is a consumable pet treat and is clamped between the two clamping blocks which are clamped by tightening the top tightening knobs and bottom tightening knobs.

3. The pet chewing device of claim 1, wherein the bottom knobs fully envelop the embedded nuts and the threaded rods such that no part of the nuts or threaded rods is exposed.
